(19) United States
(12) Patent Application Publication
(10) Pub. No.: US 2004/0156059 A1
(43) Pub. Date: Aug. 12, 2004

(54) Image forming apparatus and exposing unit checking method

(75) Inventor: Takahiro Kojima, Shizuoka-ken (JP)

Correspondence Address: FOLEY AND LARDNER, SUITE 500, 3000 K STREET NW, WASHINGTON, DC, 20007, US

(73) Assignee: Toshiba Tec Kabushiki Kaisha

(21) Appl. No.: 10/364,467

(22) Filed: Feb. 12, 2003

(51) Int. Cl. G06K 15/02; H04N 1/21; H04N 1/50

(52) U.S. Cl. 358/1.9; 358/406; 399/15; 399/72; 358/504

(57) ABSTRACT

When image formation of a print pattern for checking an exposing unit is instructed through an operation panel, print pattern information prestored in a ROM is read out in accordance with the instruction. An image of the print pattern is formed by a printer. Based on an image formation result of the print pattern, a defective part of the exposing unit or abnormality of a color image forming apparatus is determined.

### BACKGROUND OF THE INVENTION

The present invention relates to an electrophotographic image forming apparatus using an exposing unit, and to an exposing unit checking method.

In a conventional image forming apparatus using electrophotography, a print check is performed in an inspection process at the time of factory shipment, thereby to confirm image quality. If a print defect occurs in the print check, it is difficult to discern the cause of the print defect, that is, to determine whether the defect is due to an exposing unit or due to, not the exposing unit, but a printer side that performs the print check. This necessitates an inspection of all components that are empirically assumed to relate to the print defect.

### BRIEF SUMMARY OF THE INVENTION

The object of the present invention is to provide an image forming apparatus and an exposing unit checking method, which can easily determine an error-associated component at the time of performing a print check in the image forming apparatus.

In order to achieve the object, the present invention may provide an image forming apparatus that forms an image using an exposing unit, wherein when a print check is performed, the exposing unit is used to form an image of a print pattern for an exposing unit check, on the basis of print pattern information comprising at least a vertical line pattern, a horizontal line pattern and a dot pattern.

The present invention may also provide an exposing unit checking method for an image forming apparatus that forms an image using an exposing unit, comprising: using, when a print check is performed, the exposing unit to form an image of a print pattern on the basis of print pattern information comprising at least a vertical line pattern, a horizontal line pattern and a dot pattern; and determining a check result of the exposing unit on the basis of an image formation result of the vertical line pattern, horizontal line pattern and dot pattern constituting the formed print pattern.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 is a block diagram schematically showing the structure of a color image forming apparatus according to the present invention;

FIG. 2 is a cross-sectional view schematically showing the structure of the color image forming apparatus;

FIG. 3 is a flow chart illustrating a print check at a time when a print pattern is printed by the color image forming apparatus;

FIG. 4 is a view for explaining a print pattern and an image defect;

FIG. 5 is a view for explaining a print pattern and an image defect; and

FIG. 6 shows an example of the print pattern.

### DETAILED DESCRIPTION OF THE INVENTION

An embodiment of the present invention will now be described with reference to the accompanying drawings.

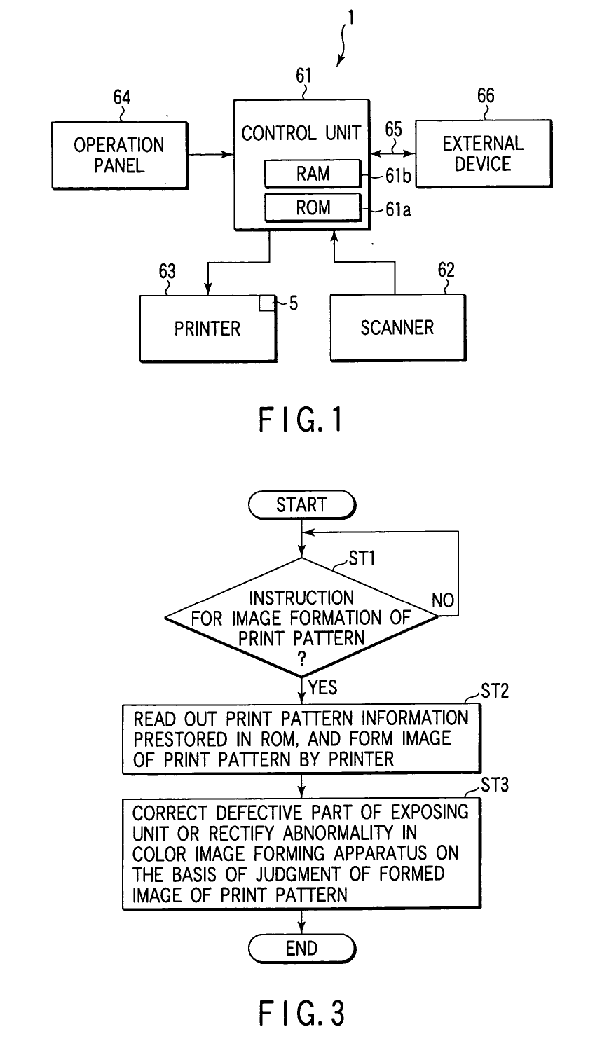

FIG. 1 is a block diagram showing the structure of a color image forming apparatus 1 according to the present invention.

As is shown in FIG. 1, the color image forming apparatus 1 comprises a control unit (CPU) 61, a scanner 62, a printer 63 and an operation panel 64. The color image forming apparatus 1 is connected to an external device 66 such as a personal computer over a network 65 such as a LAN.

The control unit (CPU) 61 controls the entirety of the color image forming apparatus 1.

The scanner 62 reads image information on a to-be-copied object (not shown) as optical light/dark information, and produces an image signal.

The printer 63 forms an image corresponding to an image signal supplied from the scanner 62 or external device 66. The printer 63 includes an exposing unit 5, as will be described later in detail.

The operation panel 64 is used to effect various settings relating to image formation and to instruct a print check.

The control unit 61 includes a ROM 61a and a RAM 61b as internal memories. The ROM 61a stores print pattern information, as will be described later in detail.

The instruction for a print check and the print pattern information may be sent from the external device 66 such as a personal computer over the network 65.

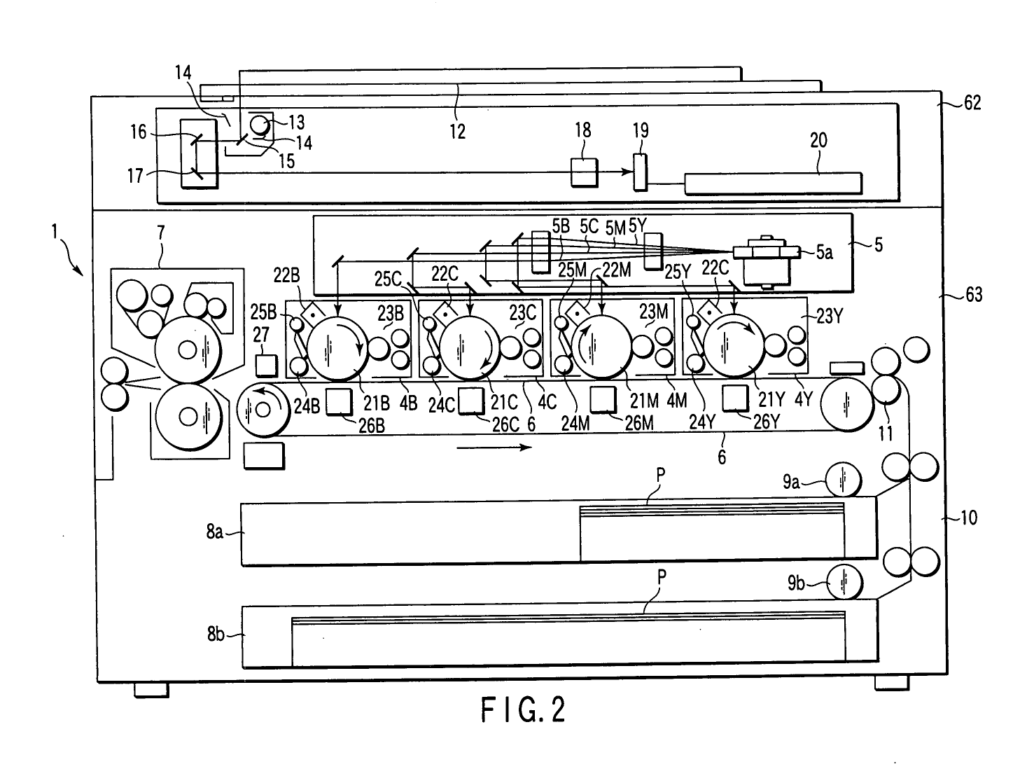

FIG. 2 shows an internal structure of the color image forming apparatus 1.

As is shown in FIG. 2, the scanner 62 includes an illumination lamp 13 for illuminating an original (not shown) placed on an original table 12; a reflector 14 for converging light from the illumination lamp 13 onto the original; an optical system for guiding the reflective light from the original to a light-receiving element 19 using reflection mirrors 15, 16 and 17 and a focusing lens 18; the light-receiving element 19 such as a CCD for converting the light from the original to an electric signal; and an image processing unit 20 for color-separating the photoelectrically converted electric signal, thus producing image signals corresponding to yellow (Y), magenta (M), cyan (C) and black (B).

As is shown in FIG. 2, the printer 63 includes four image forming units 4Y, 4M, 4C and 4B. The image forming units 4Y, 4M and 4C form images of the three subtractive primaries, Y (yellow), M (magenta) and C (cyan). The image forming unit 4B forms an image of B (black) for increasing a contrast level. The image forming units 4Y, 4M, 4C and 4B are provided with photosensitive drums 21Y, 21M, 21C and 21B, respectively.

The printer 63 further includes an exposing unit 5 that emits exposure light, e.g. a laser beam, having an optical intensity continually varying in accordance with the image signals supplied from the scanner 62 or from the outside; a transfer belt 6 for successively superimposing the images formed by the image forming units 4Y, 4M, 4C and 4B on a paper sheet P, i.e. a medium (image formation medium) on which an image is to be transferred, while conveying the paper sheet P; and a fixing device 7 that heats and presses the paper sheet P conveyed by the transfer belt 6 and the image (developer image) on the paper sheet P, thereby fixing the developer image on the sheet P.

The image forming units 4Y, 4M, 4C and 4B have similar structures and are designed to form images corresponding to the respective colors by a publicly known electrophotographic process. The photosensitive drums 21Y, 21M, 21C and 21B have the same diameter.

Around the photosensitive drum 21Y, 21M, 21C, 21B, the following components are arranged in the rotational direction: a precharger 22Y, 22M, 22C, 22B; a developing device 23Y, 23M, 23C, 23B, which contains a developer (toner) of the associated color; a transfer device 26Y, 26M, 26C, 26B; a cleaner 24Y, 24M, 24C, 24B; and a charge eraser 25Y, 25M, 25C, 25B.

The photosensitive drums 21Y, 21M, 21C and 21B are designed to form color images corresponding to laser beams 5Y, 5M, 5C and 5B, which are emitted from the exposing unit 5 in accordance with color-separated image signals and are scanned by a polygon mirror Sa.

The transfer devices 26Y, 26M, 26C and 26B are disposed below the photosensitive drums 21Y, 21M, 21C, 21B so as to face them with the transfer belt 6 interposed.

Sheet cassettes 8a and 8b are disposed at predetermined positions below the transfer belt 6. The sheet cassettes 8a and 8b contain paper sheets P on which toner images formed by the image forming units 4Y, 4M, 4C and 4B are to be transferred. The sheet cassette 8a, 8b is provided with a pick-up roller 9a, 9b for picking up the contained sheets P one by one.

A sheet convey section 10, which includes guides and rollers for conveying the sheet P picked up by the pick-up roller 9a, 9b toward the transfer belt 6, is formed between the sheet cassette 8a, 8b and the transfer belt 6. An aligning roller 11 is provided at a predetermined position on the transfer belt 6 side of the sheet convey section 10. The aligning roller 11 sets the timing for feeding the sheet P to the transfer belt 6 in order to align the position of the sheet P, which is taken out from either of the sheet cassettes and conveyed by the sheet convey section 10, with the position of the image formed in each image forming unit 4Y, 4M, 4C, 4B.

In the color image forming apparatus 1 shown in FIG. 2, when image signals are supplied from the scanner 62 or from the external device 66, a precharge power supply unit (not shown) precharges the photo-sensitive drums 21Y, 21M, 21C and 21B of image forming units 4Y, 4M, 4C and 4B at a predetermined potential in a time-series manner. Then, the exposing unit 5 applies laser beams with continually varying optical intensities based on the image signals to the photo-sensitive drums 21Y, 21M, 21C and 21B.

Thus, electrostatic latent images corresponding to color images to be output are formed on the photo-sensitive drums 21Y, 21M, 21C and 21B of the four image forming units 4Y, 4M, 4C and 4B. The timing of exposure of images on the photosensitive drums 21Y, 21M, 21C and 21B of image forming units 4Y, 4M, 4C and 4B is defined in a predetermined order in synchronism with the movement of the sheet P conveyed on the transfer belt 6.

Toner is selectively applied to the electrostatic latent images on the photosensitive drums 21Y, 21M, 21C and 21B of image forming units 4Y, 4M, 4C and 4B from the developing devices 23Y, 23M, 23C and 23B arranged in the associated image forming units 4Y, 4M, 4C and 4B and containing toners (developers) of predetermined colors. Thus, the electrostatic latent images are developed into toner images. Then, the toner images are successively transferred onto the sheet P on the transfer belt 6 by the transfer devices disposed to face the photosensitive drums 21Y, 21M, 21C and 21B with the transfer belt 6 interposed.

The sheet P is picked up from the sheet cassette, which contains paper sheets P of a pre-selected size or a size corresponding to the size of an image exposed by the exposing unit 5. The sheet P is then conveyed to the aligning roller 11 of sheet convey section 10 and temporarily stopped at the aligning roller 11.

The sheet P is fed from the aligning roller 11 to the transfer belt 6 at a timing of exposure of an image of the first color by the exposing unit 5 or at a predetermined timing. The sheet P is charged by a charger (for sheet P) provided near the sheet convey section-side roller that supports the transfer belt 6, and the sheet P is attached to the transfer belt 6.

The sheet P, on which the toner, or the toner image, formed by each image forming unit 4Y, 4M, 4C, 4B, has been transferred, is conveyed to the fixing device 7. The toner image is fused and fixed on the sheet P by the fixing device 7.

A print check, which is performed when a print pattern is printed by the color image forming apparatus 1, will now be described with reference to a flow chart of FIG. 3. In this example, a black image is described, but the same method is applicable to Y, M and C.

The print check is performed in the following manner.

When the exposing unit 5 of color image forming apparatus 1 is to be inspected, image formation of a print pattern is instructed through the operation panel 64 (ST1).

Upon receiving the instruction, the control unit 61 reads out prestored print pattern information from the ROM 61a, and performs print pattern image formation by means of the printer 63 (ST2).

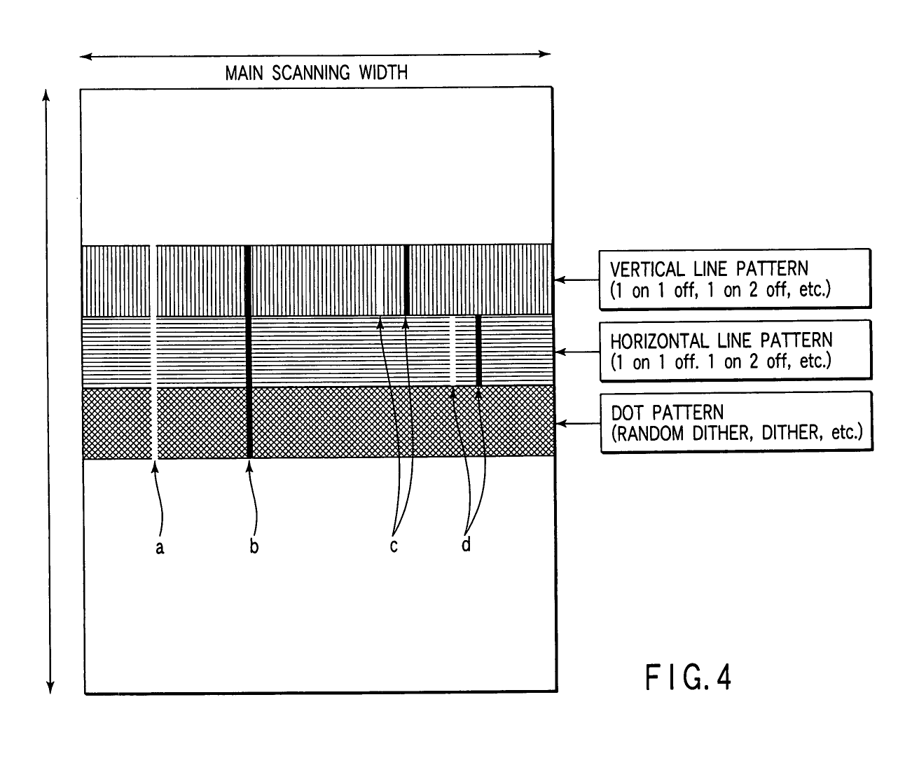

The print pattern, as shown in FIG. 4, comprises a vertical line pattern, a horizontal line pattern and a dot pattern, which are formed over a main scan width of the exposing unit 5 and arranged in the direction in which the sheet is conveyed.

The vertical line pattern is, for example, 1 on 1 off (1 dot is printed and 1 dot is not printed per resolution), or 1 on 2 off (1 dot is printed and two dots are not printed per resolution).

The horizontal line pattern is, for example, 1 on 1 off (1 dot is printed and 1 dot is not printed per resolution), or 1 on 2 off (1 dot is printed and two dots are not printed per resolution).

The dot pattern is a halftone pattern such as a random dither pattern or a dither pattern.

The following four judgments are possible according to the kind of an error image of the print pattern comprising the above-described three patterns.

1. If a “white stripe a” appears commonly on the three patterns, there is dust that shuts off exposure light from the exposing unit 5, or there is a flaw on the lens. Otherwise, it is possible that there is a problem (cause) on the side of the color image forming apparatus 1 that performs the check.

2. If a “black stripe b” appears commonly on the three patterns, there is a problem (cause) on the side of the color image forming apparatus 1 that performs the check, or there is a possibility of stray light within the exposing unit 5.

3. If a “white stripe c” or a “black stripe c” appears in the vertical line pattern alone, it is possible that there is abnormality in the profile of the main scan beam of the exposing unit 5.

4. If a “white stripe d” or a “black stripe d” appears in the horizontal line pattern alone, it is possible that there is abnormality in the profile of the sub-scan beam of the exposing unit 5.

The arrangement of the patterns may be altered for easier view.

The thickness and interval of vertical lines and horizontal lines and the size and arrangement of the dot pattern may vary depending on the relationship (models, resolution, etc.) between the exposing unit and the developing device.

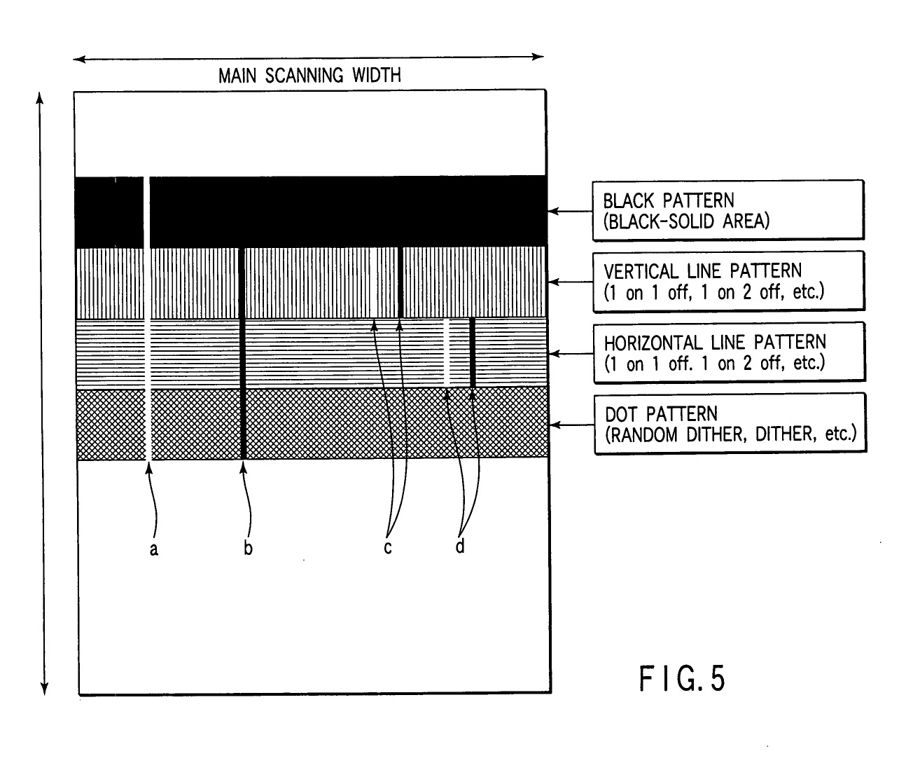

In FIG. 5, a black pattern (black-solid area) is added to the three patterns. Thereby, the afore-mentioned judgment “1” is made easier.

According to the judgments on the check, a defective point in the exposing unit 5 is corrected, or abnormality in the color image forming apparatus 1 is rectified (ST3).

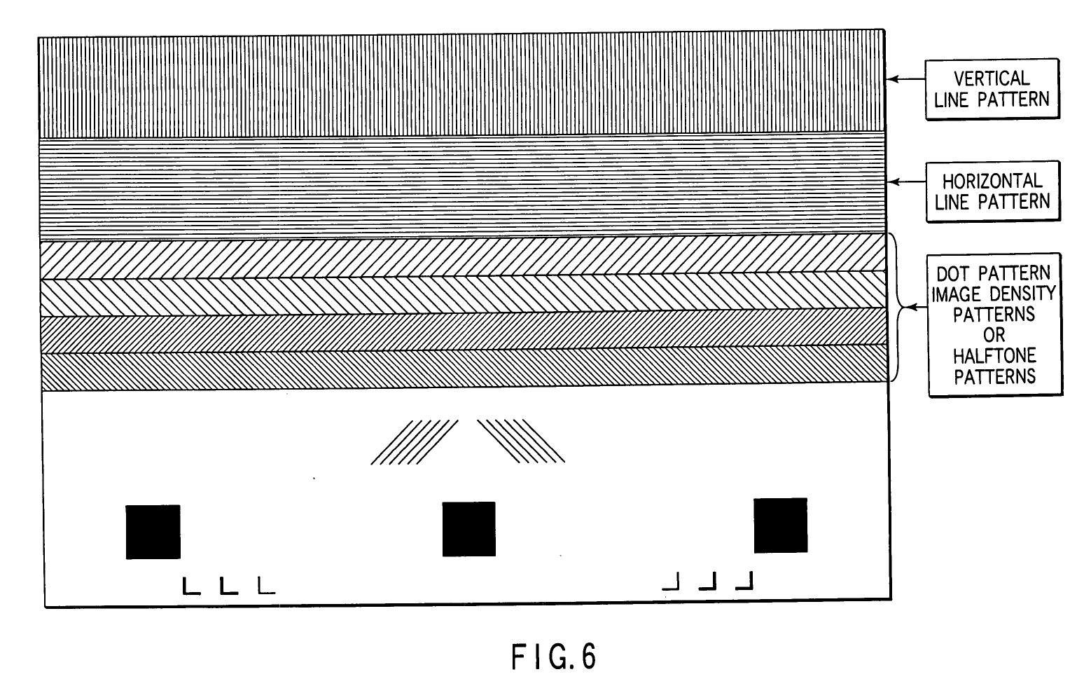

FIG. 6 shows an example in which the print pattern includes, as a dot pattern, a plurality of image densities which vary stepwise. This portion may be replaced with an arrangement of a plurality of different halftone patterns. Using the print pattern with this structure, it becomes possible to efficiently determine which part of the exposing unit is defective, or whether a defective part is present on the side of the color image forming apparatus 1.

In the above-described embodiment, the color image forming apparatus is used. This invention, however, is also applicable to a black-and-white image forming apparatus, or to a printing apparatus having an exposing unit.

As has been described above, according to the embodiment of the present invention, an error-associated component can easily be determined in the print check of the exposing unit of the image forming apparatus.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An image forming apparatus that forms an image using an exposing unit, wherein when a print check is performed, the exposing unit is used to form an image of a print pattern for an exposing unit check, on the basis of print pattern information comprising at least a vertical line pattern, a horizontal line pattern and a dot pattern.

2. The image forming apparatus according to claim 1, wherein the print pattern information is prestored in memory means.

3. The image forming apparatus according to claim 1, wherein the print pattern information is supplied from an external device such as a personal computer.

4. The image forming apparatus according to claim 1, wherein the print pattern for the exposing unit check has such a structure that the vertical line pattern, horizontal line pattern and dot pattern are arranged over a main-scan width in a direction in which a paper sheet is conveyed.

5. The image forming apparatus according to claim 1, wherein the image of the dot pattern is formed by random dither, dither, etc.

6. The image forming apparatus according to claim 1, wherein the print pattern information comprising said at least vertical line pattern, horizontal line pattern and dot pattern further includes a black pattern.

7. An image forming apparatus that forms an image using an exposing unit, comprising:
means for instructing a print check;
memory means for storing a print pattern comprising at least a vertical line pattern, a horizontal line pattern and a dot pattern; and
image forming means that uses the exposing unit to form an image of the print pattern stored in the memory means, in accordance with the instruction from the means for instructing the print check.

8. An exposing unit checking method for an image forming apparatus that forms an image using an exposing unit, comprising:
using, when a print check is performed, the exposing unit to form an image of a print pattern on the basis of print pattern information comprising at least a vertical line pattern, a horizontal line pattern and a dot pattern; and
determining a check result of the exposing unit on the basis of an image formation result of the vertical line pattern, horizontal line pattern and dot pattern constituting the formed print pattern.

9. The exposing unit checking method for an image forming apparatus, according to claim 8, wherein black pattern information serving as a black-solid area is added to the print pattern information comprising the vertical line pattern, horizontal line pattern and dot pattern, and a check result of the exposing unit is determined on the basis of an image formation result of the vertical line pattern, horizontal line pattern, dot pattern and black pattern constituting the formed print pattern.
